(19) United States
(12) Patent Application Publication
(10) Pub. No.: US 2023/0290977 A1
(43) Pub. Date: Sep. 14, 2023

(54) PERFORMANCE EVALUATION APPARATUS OF FUEL CELL ELECTRODE

(71) Applicants: Hyundai Motor Company, Seoul (KR); Kia Corporation, Seoul (KR); Gwangju Institute of Science and Technology, Buk-gu (KR)

(72) Inventors: Songi Oh, Suwon-si (KR); Won Jae Choi, Seoul (KR); Da Hee Kwak, Suwon-si (KR); Ji Hoon Jang, Suwon-si (KR); Sung Hee Shin, Incheon (KR); Chan Ho Pak, Buk-gu (KR); Do Hyung Kim, Buk-gu (KR); Hyeon Seung Jung, Buk-gu (KR)

(21) Appl. No.: 18/053,859

(22) Filed: Nov. 9, 2022

(30) Foreign Application Priority Data
Mar. 11, 2022 (KR) 10-2022-0030420

(51) Int. Cl. H01M 8/04664; H01M 8/04537; H01M 8/04701

(52) U.S. Cl. CPC H01M 8/04664; H01M 8/04544; H01M 8/04574; H01M 8/04731

(57) ABSTRACT

Disclosed is a performance evaluation apparatus of a fuel cell electrode. The performance evaluation apparatus includes a working electrode unit configured such that a working electrode is disposed therein, gas is supplied to an inside of the working electrode unit, and voltage and current are measured by a current collection rod, a counter electrode unit provided to guide mounting of the working electrode unit so that a counter electrode faces the working electrode, and configured to store an electrolyte solution, current is measured by the current collection rod, and voltage is measured by a reference electrode immersed in the electrolyte solution, a heater unit immersed in the electrolyte solution to heat the electrolyte solution, and a control unit configured to selectively adjust a temperature of the heater unit within a set temperature range, and to evaluate performance of the working electrode.

### CROSS-REFERENCE TO RELATED APPLICATIONS

This application claims under 35 U.S.C. § 119(a) the benefit of priority to Korean Patent Application No. 10-2022-0030420 filed on Mar. 11, 2022, the entire contents of which are incorporated herein by reference.

### TECHNICAL FIELD

The present disclosure relates to a performance evaluation apparatus of a fuel cell electrode. More particularly, it relates to a performance evaluation apparatus of a fuel cell electrode which may evaluate performance of the fuel cell electrode under conditions similar to the actual state of a fuel cell state to improve reliability of evaluation.

### BACKGROUND

In general, fuel cells are high-efficiency and eco-friendly power generation apparatuses which convert chemical energy produced by a reaction between hydrogen and oxygen into electrical energy, and particularly, next generation power generation apparatuses which are expected to be applied to various fields, such as portable devices, vehicles, buildings and high-capacity generation.

These fuel cells are variously classified depending on the kinds of supplied fuels and electrolyte membranes and thereamong, a polymer electrolyte membrane fuel cell is being vigorously researched as an alternative to power supplies for home use and vehicles due to low operating temperature, high power density, fast responsiveness depending on load change, high stability, etc.

In general, a fuel cell system includes various elements, such as a fuel cell stack, an inverter, a reformer, Balance of Plant (BOP), etc., and particularly, the fuel cell stack, which is the core part of the fuel cell system, includes a stack structure of unit cells, each of which includes a membrane electrode assembly (MEA), separators, etc., and physical property values of the elements in the fuel cell system have a great influence on the entire fuel cell system.

Therefore, in order to secure stable operation of a fuel cell system and reliable operating conditions of the fuel cell system, a process for evaluating and diagnosing not only the fuel cell system but also the core elements (i.e., the unit cell and the stack) of the fuel cell system is essential, and a strict performance evaluation process is required to produce a fuel cell system having reproducibility and reliability.

Since the performance of the unit cells and the stack of the fuel cell is very sensitively changed depending on surrounding conditions, such as the operating temperature, and humidity and pressure of the fuel cell, it is necessary to evaluate the fuel cell under various operating conditions, and particularly, performance evaluation of the fuel cell should be essentially performed under various environmental conditions, including cold start conditions, extremely low temperature conditions (−30° C.) below zero, and high temperature conditions (+100° C.).

However, performance evaluation apparatuses for unit cells and stacks of fuel cells, which are being used at present, have difficulty evaluating the characteristics of the unit cells and the stacks of the fuel cells under below zero temperature conditions and, although an environmental chamber is used, it is difficult to precisely control the temperature of a fuel cell and to perform evaluation conversion between low and high temperature conditions with time continuity using existing methods.

Therefore, development of a new performance evaluation apparatus for unit cells and stacks of fuel cells, which may uniformly control temperatures throughout the entirety of a unit cell or a stack of a fuel cell, and may execute continuous evaluation under low and high temperature conditions, is required.

The above information disclosed in this Background section is only for enhancement of understanding of the background of the present disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to provide a performance evaluation system of a fuel cell electrode, in which a substrate having a flow passage formed therein is installed on a working electrode so that gas may be uniformly supplied to the working electrode in the same manner as in actual unit cell evaluation, and the working electrode immersed in an electrolyte is evaluated under low and high temperature conditions corresponding to a temperature range of 25-150° C., to remove effects on performance evaluation by a cathode or an anode and an electrolyte membrane and to improve reliability of performance evaluation during performance evaluation of the working electrode.

In one aspect, the present disclosure provides a performance evaluation apparatus of a fuel cell electrode, including a working electrode unit configured such that a working electrode is disposed therein, gas is supplied to an inside of the working electrode unit, and voltage and current are measured by a current collection rod provided thereon, a counter electrode unit provided to guide mounting of the working electrode unit so that a counter electrode disposed in the counter electrode unit is disposed to face the working electrode, and configured such that an electrolyte solution is stored in the counter electrode unit, current is measured by the current collection rod, and voltage is measured by a reference electrode immersed in the electrolyte solution, a heater unit immersed in the electrolyte solution to heat the electrolyte solution, and a control unit configured to selectively adjust a temperature of the heater unit within a set temperature range, and to evaluate performance of the working electrode using current and voltage characteristics depending on a temperature of the electrolyte solution, in a state in which gas is supplied to the working electrode.

In a preferred embodiment, the working electrode unit may include a passage substrate provided in a working electrode body having the working electrode disposed therein, configured to have a supply passage to supply gas to the working electrode, and connected to the current collection rod, a press part configured to have a pair of gas passages configured to supply gas to the supply passage and to discharge the supplied gas, and provided to support the current collection rod and to press the passage substrate towards the working electrode, a stopper screw-connected to the working electrode body, and located to be hung on the counter electrode unit, and a cover coupled to the working electrode body to press the press part.

In another preferred embodiment, the working electrode unit may further include a key member coupled to the working electrode body through rotation of the cover to fix a rotated position of the press part including the current collection rod.

In still another preferred embodiment, the stopper may adjust a height of a part of the working electrode immersed in the electrolyte solution through rotation of the stopper on the working electrode body, in a state in which the stopper is hung on the counter electrode unit.

In yet another preferred embodiment, the working electrode may be operated in a gaseous atmosphere due to air supplied to the working electrode unit through the pair of gas passages and the supply passage.

In still yet another preferred embodiment, the counter electrode unit may include a main body provided to store the electrolyte solution, and configured such that the counter electrode is disposed therein, a current collection plate configured to support the counter electrode and to transmit electrons generated from the counter electrode outside, and a counter electrode cover screw-connected to an upper part of the main body, and configured to have mounting holes configured to mount the reference electrode and the heater unit therein, and a hanging hole configured to hang the working electrode unit on the counter electrode cover therethrough.

In a further preferred embodiment, the working electrode unit may be mounted in the counter electrode unit to be separable from the counter electrode unit, and thus, the working electrode may be replaceable.

In another further preferred embodiment, the counter electrode unit may be provided to be separable from the working electrode unit, and thus, the counter electrode may be replaceable.

In still another further preferred embodiment, the control unit may control the temperature of the heater unit within the set temperature range of 25-150° C. to heat the electrolyte solution, and may thus evaluate performance of the working electrode depending on the temperature of the electrolyte solution.

Other aspects and preferred embodiments of the present disclosure are discussed infra.

The above and other features of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a view showing the overall configuration of a performance evaluation apparatus of a fuel cell electrode according to one embodiment of the present disclosure;

FIG. 2 is a perspective view of a working electrode unit of the performance evaluation apparatus according to one embodiment of the present disclosure;

FIG. 3 is a view showing the disassembled state of the working electrode unit of the performance evaluation apparatus according to one embodiment of the present disclosure;

FIG. 4 is a view showing the assembled state of the working electrode unit of the performance evaluation apparatus according to one embodiment of the present disclosure;

FIG. 5 is a view showing the disassembled state of a counter electrode unit of the performance evaluation apparatus according to one embodiment of the present disclosure;

FIG. 6 is a view showing the assembled state of the counter electrode unit of the performance evaluation apparatus according to one embodiment of the present disclosure;

FIG. 7 is a view showing coupling between the working electrode unit and the counter electrode unit of the performance evaluation apparatus according to one embodiment of the present disclosure; and

FIG. 8A is a graph representing performance evaluation results by the performance evaluation apparatus according to one embodiment of the present disclosure; and

FIG. 8B is another graph representing performance evaluation results by the performance evaluation apparatus according to one embodiment of the present disclosure.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below.

Advantages and features of the present disclosure and methods for achieving the same will become apparent from the descriptions of aspects herein below with reference to the accompanying drawings and the embodiments.

However, the present disclosure is not limited to the embodiments disclosed herein and may be implemented in various different forms. The embodiments are provided to make the description of the present disclosure thorough and to fully convey the scope of the present disclosure to those skilled in the art. It is to be noted that the scope of the present disclosure is defined only by the claims.

Further, in the following description of the present disclosure, a detailed description of known functions and configurations incorporated herein will be omitted when it may make the subject matter of the present disclosure rather unclear.

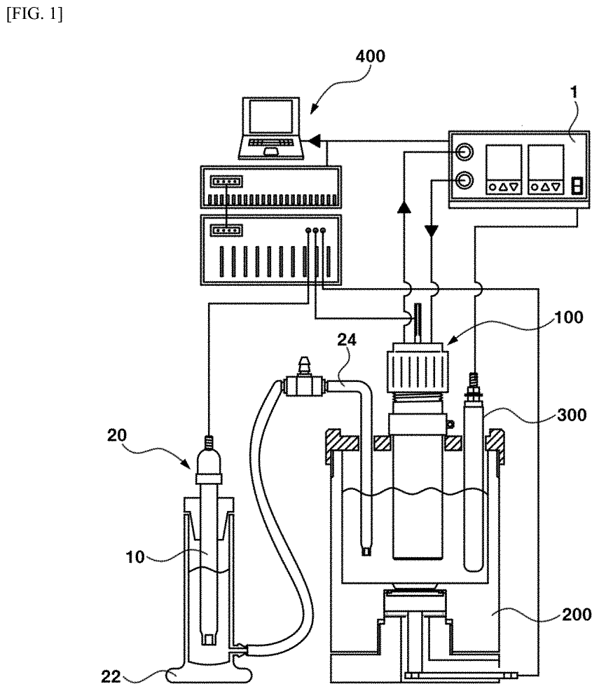

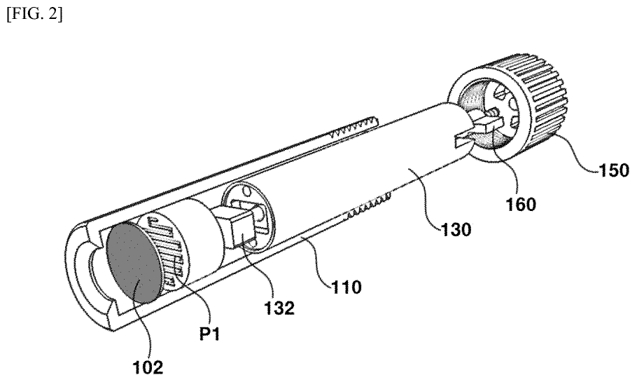

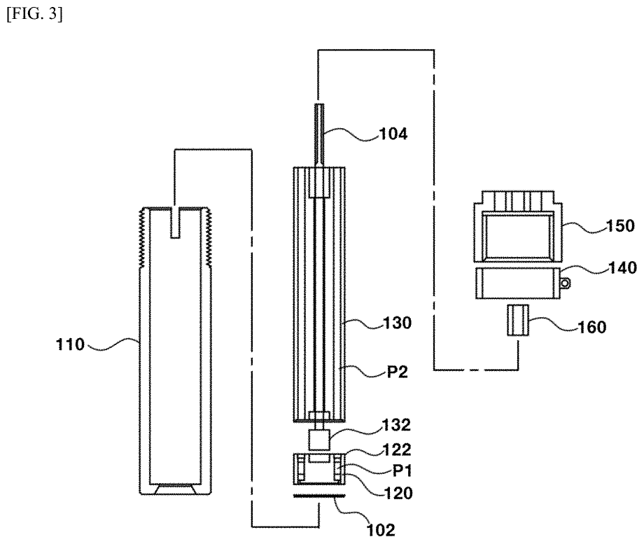

FIG. 1 is a view showing the overall configuration of a performance evaluation apparatus of a fuel cell electrode according to one embodiment of the present disclosure, FIG. 2 is a perspective view of a working electrode unit of the performance evaluation apparatus according to one embodiment of the present disclosure, and FIG. 3 is a view showing the disassembled state of the working electrode unit of the performance evaluation apparatus according to one embodiment of the present disclosure.

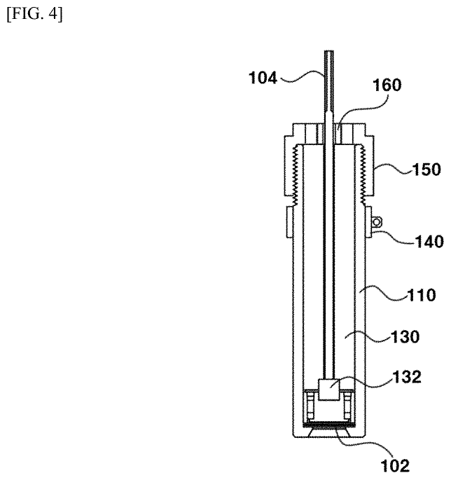

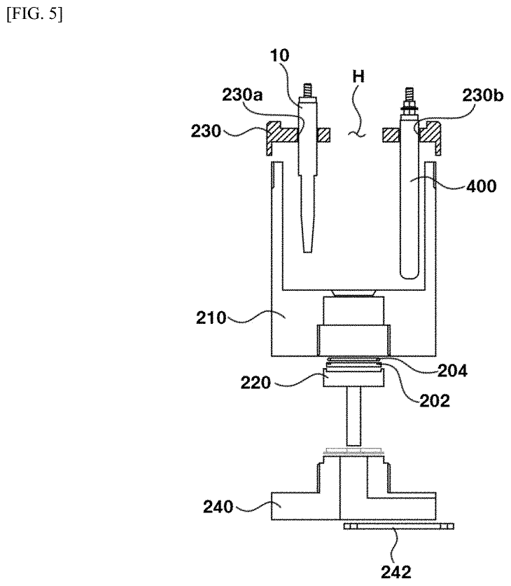

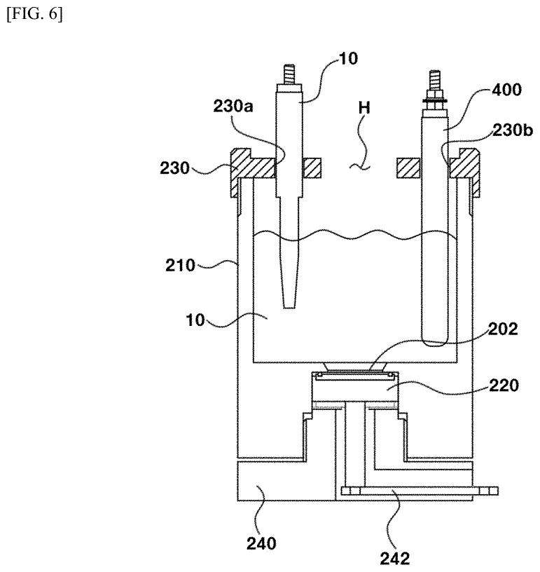

Further, FIG. 4 is a view showing the assembled state of the working electrode unit of the performance evaluation apparatus according to one embodiment of the present disclosure, FIG. 5 is a view showing the disassembled state of a counter electrode unit of the performance evaluation apparatus according to one embodiment of the present disclosure, and FIG. 6 is a view showing the assembled state of the counter electrode unit of the performance evaluation apparatus according to one embodiment of the present disclosure.

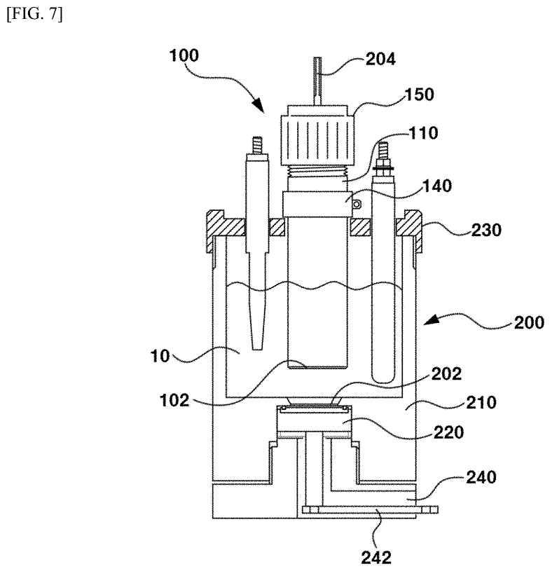

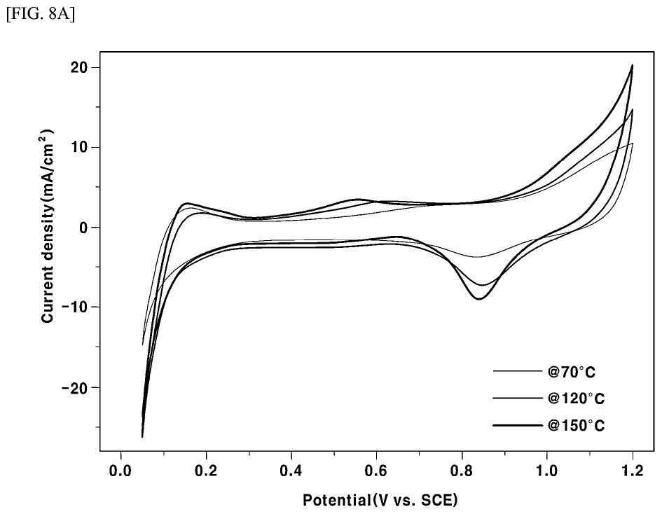

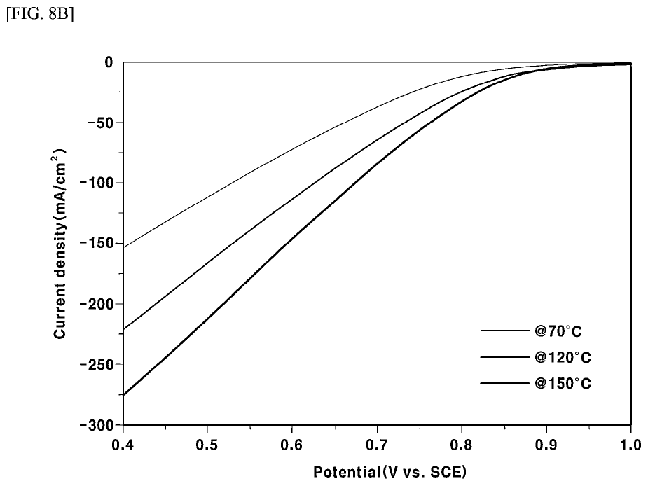

In addition, FIG. 7 is a view showing coupling between the working electrode unit and the counter electrode unit of the performance evaluation apparatus according to one embodiment of the present disclosure, and FIG. 8A is a graph representing performance evaluation results by the performance evaluation apparatus according to one embodiment of the present disclosure, and FIG. 8B is another graph representing performance evaluation results by the performance evaluation apparatus according to one embodiment of the present disclosure.

In general, a fuel cell is a power generation system which converts energy produced by an electrochemical reaction between fuel and an oxidizer into electrical energy, oxide and hydrocarbon, such as methanol or butane, are used as the fuel, and oxygen is representatively used as the oxidizer.

In such a fuel cell, the most basic unit for producing electricity is a membrane electrode assembly (MEA), and the MEA includes an electrolyte membrane and an anode (also referred to as a “fuel electrode”) and a cathode (also referred to as an “air electrode” of an “oxygen electrode”) formed on both surfaces of the electrolyte membrane.

Referring to the following reaction formula representing the electricity generation principle of the fuel cell (i.e., the reaction formula of the fuel cell in the case in which hydrogen is used as fuel), protons and electrons are generated due to the oxidation reaction of the fuel at the anode, the protons migrate to the cathode through the electrolyte membrane, oxygen (the oxidizer), the protons migrated through the electrolyte membrane and electrons react together at the cathode and thus produce water, and electrons travel to an external circuit by these reactions.

[Reaction Formula]

Anode: H₂→2H⁺+2e⁻

Cathode:½O₂+2H⁺+2e⁻→H₂O

Full Reaction Formula: H₂+½O₂→H₂O

In general, a single cell test is a general method for testing the performance of a fuel cell electrode, and may show general results, such as high activity or low activity of the fuel cell electrode.

Since these results include various variables, which affect the performance of the fuel cell, including catalyst activity, membrane conductivity, ionic conductivity, oxygen diffusivity, etc., it is difficult to analyze high or low performance of the fuel cell electrode using the results of the single cell test, and therefore, it is necessary to analyze a specific variable which affects the performance of the fuel cell electrode additionally using other electrochemical technology.

For this purpose, a performance evaluation apparatus of a fuel cell electrode according to one embodiment of the present disclosure may include a working electrode unit 100, a counter electrode unit 200, a heater unit 300, and a control unit 400, as shown in FIG. 1.

The working electrode unit 100 is configured such that a working electrode 102 is disposed therein, the working electrode 102 is operated in a gaseous atmosphere due to air supplied to the inside of the working electrode unit 100, and voltage and current in the gaseous atmosphere are measured by a current collection rod 104.

The above working electrode unit 100 includes a passage substrate 120, a press part 130, a stopper 140, and a cover 150, as shown in FIG. 2.

The passage substrate 120 is provided within a working electrode body 110 to be adhered to the working electrode 102, has a supply passage P1 configured to supply and discharge gas (air or nitrogen) therealong, is configured to supply and discharge the gas to and from the working electrode 102, and is connected to the current collection rod 104.

Here, the working electrode 102 may be formed of a gas diffusion electrode (GDE) formed by coating the upper surface of a gas diffusion layer with a catalyst layer applied so that oxygen may react therewith.

The press part 130 has a pair of gas passages P2 configured to supply gas to the inlet of the supply passage P1 and to discharge the supplied gas from the outlet of the supply passage P1, and is provided to support the current collection rod 104 and to press the passage substrate 120 towards the working electrode 102.

The press part 130 together with the passage substrate 120 is mounted in the working electrode body 110, three holes are provided in the center of the press part 130, the current collection rod 104 is inserted into the middle one of the three holes, and tubes (not shown) formed of Teflon and configured to supply and discharge gas therethrough are inserted into the remaining two holes to form the gas passages P2 connected to the supply passage P1, as shown in FIG. 3.

A pressing member 132 is formed to protrude from the press part 130, the pressing member 132 is inserted into a pressed recess 122 provided in the passage substrate 120, and thereby, when the passage substrate 120 is pressed towards the working electrode 102 by the cover 150, which will be described below, the passage substrate 120 may be effectively pressed towards the working electrode 102.

Further, the stopper 140 is screw-connected to a screw thread formed on the upper part of the working electrode body 110, and is located to be hung on the counter electrode unit 200.

More concretely, the stopper 140 is formed to have a greater diameter than the diameter of a hanging hole H of a counter electrode cover 230 provided on the counter electrode unit 200 (with reference to FIG. 5), and thus, the stopper 140 is hung on the counter electrode cover 230 so that the working electrode unit 100 may be fixed in the state in which the working electrode unit 100 is immersed in an electrolyte solution 10 contained in the counter electrode unit 200.

The stopper 140 may adjust the height of a part of the working electrode 102 immersed in the electrolyte solution 10 through rotation of the stopper 140 on the working electrode body 110, to which the stopper 140 is screw-connected, in the state in which the stopper 140 is hung on the counter electrode unit 100.

That is to say, the stopper 140 may be raised and lowered in the length direction of the working electrode body 110, when the stopper 140 is rotated in the state in which the stopper 140 is screw-connected to the working electrode body 110, as shown in FIG. 4, and thus, in order to adjust an interval with a counter electrode 202, the height of the stopper 140 hung on the hanging hole H may be adjusted by changing the position where the stopper 140 is screw-connected to the working electrode body 110 through rotation.

Further, when the cover 150, together with the stopper 140, screw-connected to the working electrode body 110 to press the press part 130 is rotated (with reference to FIG. 4), the press part 130 including the current collection rod 104 is rotated, and thus, the gas supply position of the press part 130 may be changed. Therefore, in order to prevent such a problem, a key member 160 may be further provided.

The key member 160 is formed to support the current collection rod 104 while surrounding the outer circumferential surface of the current collection rod 104, is coupled to the cover 150 in the state in which the key member 160 is not connected to the current collection rod 104, and thus, may serve only to support the current collection rod 104 and prevent the press part 130 including the current collection rod 104 from being rotated during rotation of the cover 150.

The counter electrode unit 200 guides mounting of the working electrode unit 100 so that the counter electrode 202 disposed in the counter electrode unit 200 is disposed to face the working electrode 102, and is configured such that the electrolyte solution 10 is stored in the counter electrode unit 200, current is measured by the current collection rod 104, and voltage is measured by a reference electrode 20 immersed in the electrolyte solution 10.

For this purpose, the counter electrode unit 200 includes a main body 210, a current collection plate 220 and the counter electrode cover 230, as shown in FIG. 5.

The main body 210 may be formed such that a lower cover 240 is couped thereto, may store the electrolyte solution 10 therein, and may include an O-ring member 204 configured to prevent the electrolyte solution 10 from being discharged towards the counter electrode 202.

The current collection plate 220 serves to support the counter electrode 202 for promoting current flow when current is measured by the current collection rod 104, transmits electrons generated from the counter electrode 202 formed of graphite or the like to the outside, and is assembled with a second current collection plate 242 provided on the lower cover 240 so that current is measured, as shown in FIG. 6.

The counter electrode cover 230 is screw-connected to the upper part of the main body 210, has mounting holes 230a and 230b in which the reference electrode 20 and the heater unit 300 are mounted, and the hanging hole H through which the stopper 140 of the working electrode unit 100 is hung on the counter electrode cover 230, and thereby, may allow the working electrode unit 100 to be mounted in the counter electrode unit 200, as shown in FIG. 7.

In the above-described structure, the working electrode unit 100 is mounted in the counter electrode unit 200 to be separable from the counter electrode unit 200 and thus the working electrode 102 is replaceable, and the counter electrode unit 200 is provided to be separable from the working electrode unit 100 and thus the counter electrode 202 is replaceable, as needed.

Further, the reference electrode 20 may be directly inserted into the mounting hole 230a to be fixed thereto, or a salt bridge tube 24 connected to the reference electrode 20 immersed in an electrolyte beaker 22 by a salt bridge may be fixed to the mounting hole 230a (with reference to FIG. 1).

The heater unit 300 is fixed to the mounting hole 230b to be immersed in the electrolyte solution 10, and controls a temperature controller 1 through the control unit 400 to heat the electrolyte solution 10 (with reference to FIG. 1).

Preferably, the control unit 400 controls the temperature of the heater unit 300 within a set temperature range of 25-150° C. to heat the electrolyte solution 10, varies the temperature condition of the electrolyte solution 10 through heating to correspond to a high temperature or low temperature condition, and may thus analyze a temperature variable affecting the performance of the fuel cell electrode, so that the performance of the working electrode 102 depending on temperature environments may be evaluated.

### Evaluation Example

An anode gas diffusion electrode was cut to fit into a working electrode area formed in the working electrode body 110, and was assembled in the working electrode body 110 as the working electrode 102.

The working electrode 102 and an Ag/AgCl electrode serving as the reference electrode 20 were coupled to the counter electrode unit 200 which stores H₃PO₄ (˜100%) as the electrolyte solution 10.

10-1000 sccm of nitrogen was supplied to the supply passage P1 through the gas passages P2, and the electrodes 102, 20 and 200 were activated by performing Cyclic Voltammetry (CV) within the potential range of 0.2 V-0.8 V (vs. RHE).

In the state in which the electrolyte beaker 22 is filled with 0.1-2 M HClO₄, the Ag/AgCl electrode serving as the reference electrode 20 was separated from the counter electrode unit 200, and was immersed in the electrolyte beaker 22.

The working electrode 102 and the salt bridge tube 24 were coupled to the counter electrode unit 200 which stores H₃PO₄ (˜100%) as the electrolyte solution 10, and the temperature of the electrolyte solution 10 was increased within the temperature range of 25-150° C. through control of the heater unit 300.

Here, 10-1000 sccm of nitrogen was supplied to the supply passage P1 through the gas passages P2, and Cyclic Voltammetry (CV) was performed within the potential range of 0.05 V-1.2 V (vs. RHE), thereby obtaining results.

FIG. 8A is a graph representing results of Cyclic Voltammetry (CV), i.e., results of evaluation performed, focused on that electrochemical evaluation may be performed within the set temperature range of 25-150° C. of the electrolyte solution 10, and in this case, 85% H₃PO₄ was used as the electrolyte solution 10 at temperatures of 70° C., 120° C. and 150° C. 100 sccm of nitrogen was supplied to the working electrode 102, and results of evaluation using Cyclic Voltammetry (CV) performed within the potential range of 0.05 V-1.2 V (vs. RHE) at a scan rate of 10 mV/s show that a high current density was output at a relatively high temperature of 150° C. within the potential range of 1.0 V-1.2 V (vs. RHE).

Here, since adsorption and desorption of hydrogen occur in the potential range of 0.1 V-0.3 V (with reference to FIG. 8A), as results of calculation of the active surface area of a catalyst as a peak area, it may be confirmed that the catalyst exhibits similar active surface areas throughout all temperature ranges, and thus, it may be proved that the performance evaluation apparatus according to this embodiment is capable of being used in all temperature ranges and, through the corresponding evaluation, environment for performing evaluation of both low-temperature and high-temperature fuel cells may be created.

Subsequently, 10-1000 sccm of oxygen was supplied to the supply passage P1 through the gas passages P2, and Linear Sweep Voltammetry (LSV) was performed within the potential range of 1.1 V-0.4 V (vs. RHE), thereby obtaining results.

FIG. 8B is a graph representing results of Linear Sweep Voltammetry (LSV), i.e., results of oxygen reduction reaction, and in this case, activity of the catalyst was checked while decreasing voltage starting from a high voltage at a designated scan rate (within the range of 1.1 V-0.4 V). 85% H₃PO₄ was used as the electrolyte solution 10 at temperatures of 70° C., 120° C. and 150° C., 100 sccm of oxygen was supplied to the working electrode 102, and results of evaluation were obtained by performing Linear Sweep Voltammetry (LSV) within the potential range of 1.1 V-0.4 V (vs. RHE) at a scan rate of 10 mV/s. It may be analyzed that, as the slope of a curve increases and the curve is shifted to the right, activity of the catalyst increases, and it may be evaluated that the catalyst exhibits high activity, as the temperature of the electrolyte solution 10 set using the performance evaluation apparatus according to this embodiment increases within the temperature range of 25-150° C., i.e., at a high temperature of 150° C.

The present disclosure provides a performance evaluation system of a fuel cell electrode, in which a substrate having a flow passage formed therein is installed on a working electrode so that gas may be uniformly supplied to the working electrode in the same manner as in actual unit cell evaluation, and the working electrode immersed in an electrolyte is evaluated under low and high temperature conditions corresponding to a temperature range of 25-150° C., to remove effects on performance evaluation by a cathode or an anode and an electrolyte membrane and to improve reliability of performance evaluation during performance evaluation of the working electrode.

Therefore, the performance evaluation system according to the present disclosure may perform comparative evaluation of intrinsic catalyst performance only through the working electrode without going through a process for manufacturing a membrane electrode assembly (MEA) of a unit cell.

Further, the performance evaluation system according to the present disclosure may execute performance evaluation under acidic and basic conditions, because a working electrode unit, a counter electrode unit and a heater unit are formed of a material having acid resistance and corrosion resistance, such as Teflon.

As is apparent from the above description, the present disclosure provides a performance evaluation system of a fuel cell electrode, in which a substrate having a flow passage formed therein is installed on a working electrode so that gas may be uniformly supplied to the working electrode in the same manner as in actual unit cell evaluation, and the working electrode immersed in an electrolyte is evaluated under low and high temperature conditions corresponding to a temperature range of 25-150° C., to remove effects on performance evaluation by a cathode or an anode and an electrolyte membrane and to improve reliability of performance evaluation during performance evaluation of the working electrode.

Therefore, the performance evaluation system according to the present disclosure may perform comparative evaluation of intrinsic catalyst performance only through the working electrode without going through a process for manufacturing a membrane electrode assembly (MEA) of a unit cell.

Further, the performance evaluation system according to the present disclosure may execute performance evaluation under acidic and basic conditions, because a working electrode unit, a counter electrode unit and a heater unit are formed of a material having acid resistance and corrosion resistance, such as Teflon.

The present disclosure has been described in detail with reference to preferred embodiments thereof. However, it will be appreciated by those skilled in the art that changes may be made in these embodiments without departing from the principles and spirit of the present disclosure, the scope of which is defined in the appended claims and their equivalents.

What is claimed is:

1. A performance evaluation apparatus of a fuel cell electrode, comprising:
a working electrode unit configured such that a working electrode is disposed therein, gas is supplied to an inside of the working electrode unit, and voltage and current are measured by a current collection rod provided thereon;
a counter electrode unit provided to guide mounting of the working electrode unit so that a counter electrode disposed in the counter electrode unit is disposed to face the working electrode, and configured such that an electrolyte solution is stored in the counter electrode unit, current is measured by the current collection rod, and voltage is measured by a reference electrode immersed in the electrolyte solution;
a heater unit immersed in the electrolyte solution to heat the electrolyte solution; and
a control unit configured to selectively adjust a temperature of the heater unit within a set temperature range, and to evaluate performance of the working electrode using current and voltage characteristics depending on a temperature of the electrolyte solution, in a state in which gas is supplied to the working electrode.

2. The performance evaluation apparatus of claim 1, wherein the working electrode unit comprises:
a passage substrate provided in a working electrode body having the working electrode disposed therein, configured to have a supply passage to supply gas to the working electrode, and connected to the current collection rod;
a press part configured to have a pair of gas passages configured to supply gas to the supply passage and to discharge the supplied gas, and provided to support the current collection rod and to press the passage substrate towards the working electrode;
a stopper screw-connected to the working electrode body, and located to be hung on the counter electrode unit; and
a cover coupled to the working electrode body to press the press part.

3. The performance evaluation apparatus of claim 2, wherein the working electrode unit further comprises a key member coupled to the working electrode body through rotation of the cover to fix a rotated position of the press part comprising the current collection rod.

4. The performance evaluation apparatus of claim 2, wherein the stopper adjusts a height of a part of the working electrode immersed in the electrolyte solution through rotation of the stopper on the working electrode body, in a state in which the stopper is hung on the counter electrode unit.

5. The performance evaluation apparatus of claim 2, wherein the working electrode is operated in a gaseous atmosphere due to air supplied to the working electrode unit through the pair of gas passages and the supply passage.

6. The performance evaluation apparatus of claim 1, wherein the counter electrode unit comprises:
a main body provided to store the electrolyte solution, and configured such that the counter electrode is disposed therein;
a current collection plate configured to support the counter electrode and to transmit electrons generated from the counter electrode outside; and
a counter electrode cover screw-connected to an upper part of the main body, and configured to have mounting holes configured to mount the reference electrode and the heater unit therein, and a hanging hole configured to hang the working electrode unit on the counter electrode cover therethrough.

7. The performance evaluation apparatus of claim 1, wherein the working electrode unit is mounted in the counter electrode unit to be separable from the counter electrode unit, and thus, the working electrode is replaceable.

8. The performance evaluation apparatus of claim 1, wherein the counter electrode unit is provided to be separable from the working electrode unit, and thus, the counter electrode is replaceable.

9. The performance evaluation apparatus of claim 1, wherein the control unit controls the temperature of the heater unit within the set temperature range of 25-150° C. to heat the electrolyte solution, and thus, evaluates performance of the working electrode depending on the temperature of the electrolyte solution.
